(19) United States
(12) Patent Application Publication
(10) Pub. No.: US 2005/0236407 A1
(43) Pub. Date: Oct. 27, 2005

(54) Low cost food processing, preparation, and handling devices manufactured from conductive loaded resin-based materials

(75) Inventor: Thomas Aisenbrey, Littleton, CO (US)

Correspondence Address: STEPHEN B. ACKERMAN, 28 DAVIS AVENUE, POUGHKEEPSIE, NY, 12603, US

(73) Assignee: Integral Technologies, Inc.

(21) Appl. No.: 11/138,858

(22) Filed: May 26, 2005

Related U.S. Application Data
(63) Continuation-in-part of application No. 10/877,092, filed on Jun. 25, 2004.
Application No. 10/877,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/576,013, filed on Jun. 1, 2004.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. H05B 6/80

(52) U.S. Cl. 219/730

(57) ABSTRACT

Food processing, preparation, and handling devices are formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are metals or conductive non-metals or metal plated non-metals. The micron conductive fibers may be metal fiber or metal plated fiber. Further, the metal plated fiber may be formed by plating metal onto a metal fiber or by plating metal onto a non-metal fiber. Any platable fiber may be used as the core for a non-metal fiber. Superconductor metals may also be used as micron conductive fibers and/or as metal plating onto fibers in the present invention.

### RELATED PATENT APPLICATIONS

This Patent Application is related to U.S. patent application INT04-023B, Ser. No. ______, and filed on ______, which is herein incorporated by reference in its entirety.

This Patent Application claims priority to the U.S. Provisional Patent Application 60/576,013, filed on Jun. 1, 2004, which is herein incorporated by reference in its entirety.

This Patent Application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, now issued as U.S. Pat. No. 6,870,516, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001, all of which are incorporated by reference in their entirety.

### BACKGROUND OF THE INVENTION

(1) Field of the Invention

This invention relates to food processing, preparation, and handling devices and, more particularly, to food processing, preparation, and handling devices molded of conductive loaded resin-based materials comprising micron conductive powders, micron conductive fibers, or a combination thereof, substantially homogenized within a base resin when molded. This manufacturing process yields a conductive part or material usable within the EMF or electronic spectrum(s).

(2) Description of the Prior Art

In the prior art, spatulas, scrapers and similar utensils used in food processing frequently comprise common plastic materials. It is possible for a broken piece of the plastic utensil to become embedded in a salable food product. However, the piece of plastic is not detectable by metal-detector inspection equipment. Therefore, the incidental inclusion of a piece of such a plastic item is a quality issue for a food processing facility. An important object of the present invention is to provide a plastic food processing item that is detectable by metal-detector inspection equipment.

Several prior art inventions relate to food processing, preparation, and handling devices. U.S. Pat. No. 6,113,482 to Licata teaches the use of a metal-detectable elastomeric material in producing seals and or diaphragms such as those used for sensing and pumping in the food processing industry. This invention utilizes a mixture of iron, nickel and molybdenum powders in the elastomeric matrix. U.S. Pat. No. 6,177,113 B1 to Kress et al teaches a method for detecting non-metallic equipment fragments or pieces in food products during the manufacturing process by fabricating piece parts such as plastic diaphragms used in pumps, blades or impellers in mixers or smaller parts such as washers or O-rings used in the food equipment out of a polymer and stainless steel powder blend. This invention also teaches of a method of detecting the presence of plastic or elastomeric food covering material that also comprises a polymer and particulate metal powder. U.S. Pat. No. 5,235,880 to Wilbur et al teaches a detectable cutter knife molded of a plastic material utilizing an amount of metallic material in the shank sufficient to stimulate a metal detector. U.S. Pat. No. 6,011,090 to Sakogawa et al teaches a resin composition comprising a resin and conductive filler which is useful for example in office appliances or equipment, automobiles, electric appliances, medical instruments, equipments for food products, electric wires and sundries. The invention teaches the use of carbon black, graphite or carbon fibers, a metal powder such as aluminum or magnesium powder, a metal material such as metal fibers, or a surface-treated metal oxide powder as the conductive filler with carbon black being the preferred method.

### SUMMARY OF THE INVENTION

A principal object of the present invention is to provide effective food processing, preparation, and handling devices.

A further object of the present invention is to provide a method to form food processing, preparation, and handling devices.

A further object of the present invention is to provide food processing, preparation, and handling devices molded of conductive loaded resin-based materials.

A yet further object of the present invention is to provide a food handling utensil device comprising conductive loaded resin-based material.

A yet further object of the present invention is to provide a food handling utensil such as a spoon, fork, or scoop comprising conductive loaded resin-based material.

A yet further object of the present invention is to provide a food handling container comprising conductive loaded resin-based material.

A yet further object of the present invention is to provide a food handling container such as a mixing bowl, bucket or pitcher comprising conductive loaded resin-based material.

A yet further object of the present invention is to provide a food handling tray device comprising conductive loaded resin-based material.

A yet further object of the present invention is to provide a food handling glove device comprising conductive loaded resin-based material.

A yet further object of the present invention is to provide a food handling piping device comprising conductive loaded resin-based material.

A yet further object of the present invention is to provide food processing, preparation, and handling devices molded of conductive loaded resin-based material where the electrical or thermal characteristics can be altered or the visual characteristics can be altered by forming a metal layer over the conductive loaded resin-based material.

A yet further object of the present invention is to provide methods to fabricate food processing, preparation, and handling devices from a conductive loaded resin-based material incorporating various forms of the material.

In accordance with the objects of this invention, a food handling device is achieved. The device comprises a conductive loaded, resin-based material comprising conductive materials in a base resin host. The percent by weight of the conductive materials is between 20% and 50% of the total weight of the conductive loaded resin-based material.

Also in accordance with the objects of this invention, a food handling device is achieved. The device comprises a hollow tube comprising a conductive loaded, resin-based material comprising conductive materials in a base resin host. The percent by weight of the conductive materials is between 20% and 50% of the total weight of the conductive loaded resin-based material.

Also in accordance with the objects of this invention, a food handling device is achieved. The device comprises a food contact portion comprising a conductive loaded, resin-based material comprising micron conductive fiber in a base resin host. The percent by weight of the conductive fiber is between 20% and 50% of the total weight of the conductive loaded resin-based material. A handle is included.

Also in accordance with the objects of this invention, a method to form a food handling device is achieved. The method comprises providing a conductive loaded, resin-based material comprising conductive materials in a resin-based host. The conductive loaded, resin-based material is molded into a food handling device.

Also in accordance with the objects of this invention, a method to form a conductive fastening device is achieved. The method comprises providing a conductive loaded, resin-based material comprising conductive materials in a resin-based host. The percent by weight of the conductive materials is between 20% and 40% of the total weight of the conductive loaded resin-based material. The conductive loaded, resin-based material is molded into a hollow tube device.

Also in accordance with the objects of this invention, a method to form a food handling device is achieved. The method comprises providing a conductive loaded, resin-based material comprising micron conductive fiber in a resin-based host. The percent by weight of the micron conductive fiber is between 20% and 50% of the total weight of the conductive loaded resin-based material. The conductive loaded, resin-based material is molded into a food handling device comprising a food contact portion and a handle.

### BRIEF DESCRIPTION OF THE DRAWINGS

In the accompanying drawings forming a material part of this description, there is shown:

FIG. 1a a illustrates a first preferred embodiment of the present invention showing a food preparation utensil formed of conductive loaded resin-based material.

FIG. 1b illustrates a second preferred embodiment of the present invention showing a food container or food transporting device formed of conductive loaded resin-based material.

FIG. 1c illustrates a third preferred embodiment of the present invention showing a glove comprising conductive loaded resin-based material.

FIG. 1d illustrates a fourth preferred embodiment of the present invention showing a conductive loaded resin-based tube for use in the food processing industry.

FIG. 1e illustrates a fifth preferred embodiment of the present invention showing a conductive loaded resin-based tube for use in the food processing industry.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold food processing, preparation, and handling devices of a conductive loaded resin-based material.

FIGS. 7a, 7b, and 7c illustrate sixth, seventh, and eighth preferred embodiments of the present invention showing additional food handling devices of a spoon, a fork, and a scoop formed of the conductive loaded resin-based material.

FIGS. 8a, 8b, and 8c illustrate ninth, tenth, and eleventh preferred embodiments of the present invention showing additional food container devices of a mixing bowl, a bucket, and a pitcher formed of the conductive loaded resin-based material.

### DESCRIPTION OF THE PREFERRED EMBODIMENTS

This invention relates to food processing, preparation, and handling devices molded of conductive loaded resin-based materials comprising micron conductive powders, micron conductive fibers, or a combination thereof, substantially homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are substantially homogenized within the resin during the molding process, providing the electrical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of food processing, preparation, and handling devices fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the food processing, preparation, and handling devices are substantially homogenized together using molding techniques and or methods such as injection molding, over-molding, insert molding, thermo-set, protrusion, extrusion, calendaring, or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

In the conductive loaded resin-based material, electrons travel from point to point when under stress, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive loading concentration, that is, the separation between the conductive loading particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductive loaded resin-based material are altered when molded into a structure. A substantially homogenized conductive microstructure of delocalized valance electrons is created. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

The use of conductive loaded resin-based materials in the fabrication of food processing, preparation, and handling devices significantly lowers the cost of materials and the design and manufacturing processes used to hold ease of close tolerances, by forming these materials into desired shapes and sizes. The devices can be manufactured into infinite shapes and sizes using conventional forming methods such as injection molding, over-molding, or extrusion, calendaring, or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are substantially homogenized together within the base resin, during the molding process, yielding an easy to produce low cost, electrically conductive, close tolerance manufactured part or circuit. The resulting molded article comprises a three dimensional, continuous network of conductive loading and polymer matrix. Exemplary micron conductive powders include carbons, graphites, amines or the like, and/or of metal powders such as nickel, copper, silver, aluminum, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. The addition of conductive powder to the micron conductive fiber loading may increase the surface conductivity of the molded part, particularly in areas where a skinning effect occurs during molding.

The micron conductive fibers may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, or the like, or combinations thereof. Exemplary metal plating materials include, but are not limited to, copper, nickel, cobalt, silver, gold, palladium, platinum, ruthenium, and rhodium, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention. The structural material is a material such as any polymer resin. Thermoplastic or thermosetting resin-based materials may be used according to the characteristics required.

The resin-based structural material loaded with micron conductive powders, micron conductive fibers, or in combination thereof can be molded, using conventional molding methods such as injection molding or over-molding, or extrusion, or calendaring, to create desired shapes and sizes. The molded conductive loaded resin-based materials can also be stamped, cut or milled as desired to form create the desired shape form factor(s) of the food processing, preparation, and handling devices. The doping composition and directionality associated with the micron conductors within the loaded base resins can affect the electrical and structural characteristics of the devices and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming food processing, preparation, and handling devices that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in applications as described herein.

The substantially homogeneous mixing of micron conductive fiber and/or micron conductive powder and base resin described in the present invention may also be described as doping. That is, the substantially homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder into a base resin.

As an additional and important feature of the present invention, the molded conductor loaded resin-based material exhibits excellent thermal dissipation characteristics. Therefore, food processing, preparation, and handling devices manufactured from the molded conductor loaded resin-based material can provide added thermal dissipation capabilities to the application. For example, heat can be dissipated from electrical devices physically and/or electrically connected to devices of the present invention.

As a significant advantage of the present invention, food processing, preparation, and handling devices constructed of the conductive loaded resin-based material can be easily interfaced to an electrical circuit or grounded. In one embodiment, a wire can be attached to a conductive loaded resin-based device via a screw that is fastened to the device. For example, a simple sheet-metal type, self tapping screw, when fastened to the material, can achieve excellent electrical connectivity via the conductive matrix of the conductive loaded resin-based-material. To facilitate this approach a boss may be molded into the conductive loaded resin-based material to accommodate such a screw. Alternatively, if a solderable screw material, such as copper, is used, then a wire can be soldered to the screw that is embedded into the conductive loaded resin-based material. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the device and a grounding wire.

Where a metal layer is formed over the surface of the conductive loaded resin-based material, any of several techniques may be used to form this metal layer. This metal layer may be used for visual enhancement of the molded conductive loaded resin-based material article or to otherwise alter performance properties. Well-known techniques, such as electroless metal plating, electro metal plating, metal vapor deposition, metallic painting, or the like, may be applied to the formation of this metal layer. If metal plating is used, then the resin-based structural material of the conductive loaded, resin-based material is one that can be metal plated. There are many of the polymer resins that can be plated with metal layers. Electroless plating is typically a multiple-stage chemical process where, for example, a thin copper layer is first deposited to form a conductive layer. This conductive layer is then used as an electrode for the subsequent plating of a thicker metal layer.

A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

Another method to provide connectivity to the conductive loaded resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductive loaded resin-based material at the location of the applied solderable ink. Many other types of solderable inks can be used to provide this solderable surface onto the conductive loaded resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductive loaded resin-based material may be formed of the present invention to create a magnetic or magnetizable form of the material. Ferromagnetic micron conductive fibers and/or ferromagnetic conductive powders are mixed with the base resin. Ferrite materials and/or rare earth magnetic materials are added as a conductive loading to the base resin. With the substantially homogeneous mixing of the ferromagnetic micron conductive fibers and/or micron conductive powders, the ferromagnetic conductive loaded resin-based material is able to produce an excellent low cost, low weight magnetize-able item. The magnets and magnetic devices of the present invention can be magnetized during or after the molding process. The magnetic strength of the magnets and magnetic devices can be varied by adjusting the amount of ferromagnetic micron conductive fibers and/or ferromagnetic micron conductive powders that are incorporated with the base resin. By increasing the amount of the ferromagnetic doping, the strength of the magnet or magnetic devices is increased. The substantially homogenous mixing of the conductive fiber network allows for a substantial amount of fiber to be added to the base resin without causing the structural integrity of the item to decline. The ferromagnetic conductive loaded resin-based magnets display the excellent physical properties of the base resin, including flexibility, moldability, strength, and resistance to environmental corrosion, along with excellent magnetic ability. In addition, the unique ferromagnetic conductive loaded resin-based material facilitates formation of items that exhibit excellent thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fiber to cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductive loaded resin-based material may be magnetized, after molding, by exposing the molded article to a strong magnetic field. Alternatively, a strong magnetic field may be used to magnetize the ferromagnetic conductive loaded resin-based material during the molding process.

The ferromagnetic conductive loading is in the form of fiber, powder, or a combination of fiber and powder. The micron conductive powder may be metal fiber or metal plated fiber. If metal plated fiber is used, then the core fiber is a platable material and may be metal or non-metal. Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials. A ferromagnetic conductive loading may be combined with a non-ferromagnetic conductive loading to form a conductive loaded resin-based material that combines excellent conductive qualities with magnetic capabilities.

As an additional and important feature of the present invention, the molded conductive loaded resin-based material exhibits excellent thermal dissipation characteristics. Therefore, food processing, preparation, and handling devices manufactured from the molded conductor loaded resin-based material can provide added thermal dissipation capabilities to the application. For example, heat can be dissipated from food items to a tray, pan, utensil, and/or tube of the present invention.

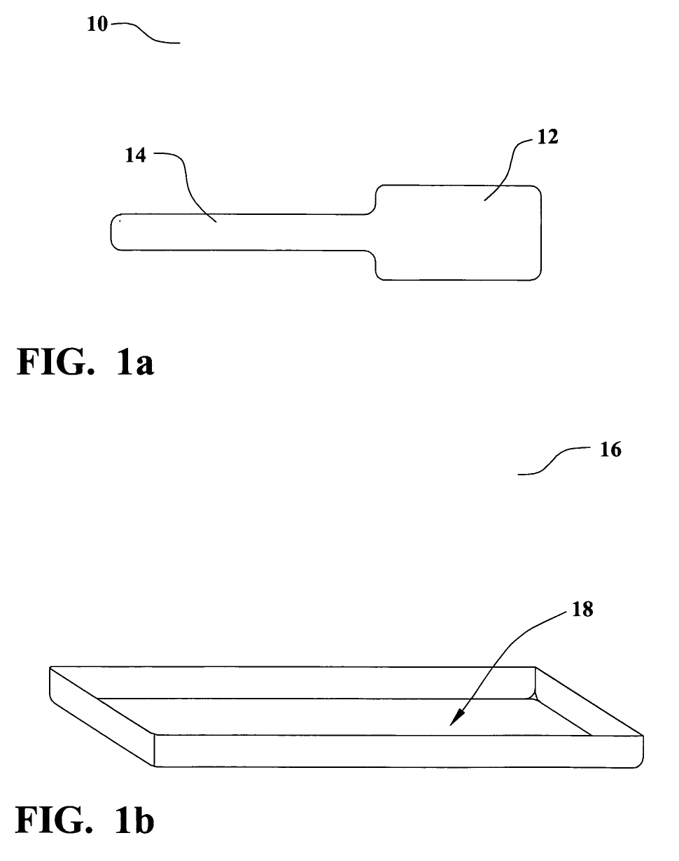

Referring now to FIG. 1a, a first preferred embodiment of the present invention is illustrated. A low cost food processing, preparation, or handling utensil comprising conductive loaded resin-based material is shown. Several important features of the present invention are discussed below. The first preferred embodiment 10 of the present invention shows a utensil 10 comprising a food contact portion 12 and a handle portion 14. The utensil 10 is fabricated from conductive loaded resin-based material. The conductive loaded resin-based utensil 10 is detectable by metal-detector inspection equipment as is common in the food processing industry. This metal-detection characteristic of the conductive loaded resin-based material utensil is extremely beneficial in the food processing industry in that any portion of a utensil which is inadvertently placed in the finished food product is detected by metal-detector equipment in the food processing facility. As another useful feature, if ferromagnetic loading is used in the conductive loaded resin-based material, then pieces of the utensil 10 are easily detectable and/or removable by a magnetic method. As an additional feature, the utensil 10 can be made significantly lighter than prior art metal utensils.

The conductive loaded resin-based material utensil 10 of the present invention is doped with conductive material homogeneously mixed into the resin-based host thereby making the utensil, or any portion of the utensil, detectable by the metal-detection equipment common in the food processing facility. This represents a very significant cost savings to the food processing facility by avoiding the opportunity for large amounts of scrapped food and line downtime associated with common plastic utensil pieces being embedded in the finished food product. As an additional advantage, conductive loaded resin-based material utensils provide increased strength when compared to the common plastic counterpart utensils found in the prior art.

It is understood that the exemplary utensil 10 represents the many utensils used for similar purposes in the food industry and that the scope of the present invention is not limited to utensils of the shape shown in FIG. 1a. For example, spatulas, paddles, and/or scrapers are utensils used in the food industry. A conductive loaded resin-based scraper provides the same benefits as those described above for the exemplary utensil 10. The conductive loaded resin-based utensils of the present invention may be formed into almost any shape and size that are required for the application.

As mentioned previously, conductive loaded resin-based materials are thermally conductive. Still referring to FIG. 1a, in certain applications it is desirable to thermally insulate the handle portion 14 of the utensil 10 from the food contact portion 12. Therefore, as an alternate design, the handle portion 14 of the conductive loaded resin-based utensil 10 is over-molded with a non-thermally conductive base resin, not shown. This resin is preferably the same base resin used to form the conductive loaded resin-based material of the utensil 10. This over-molded handle portion, not shown, provides thermal isolation from the food contact portion 12. Similarly, the entire utensil may be over-molded if desired.

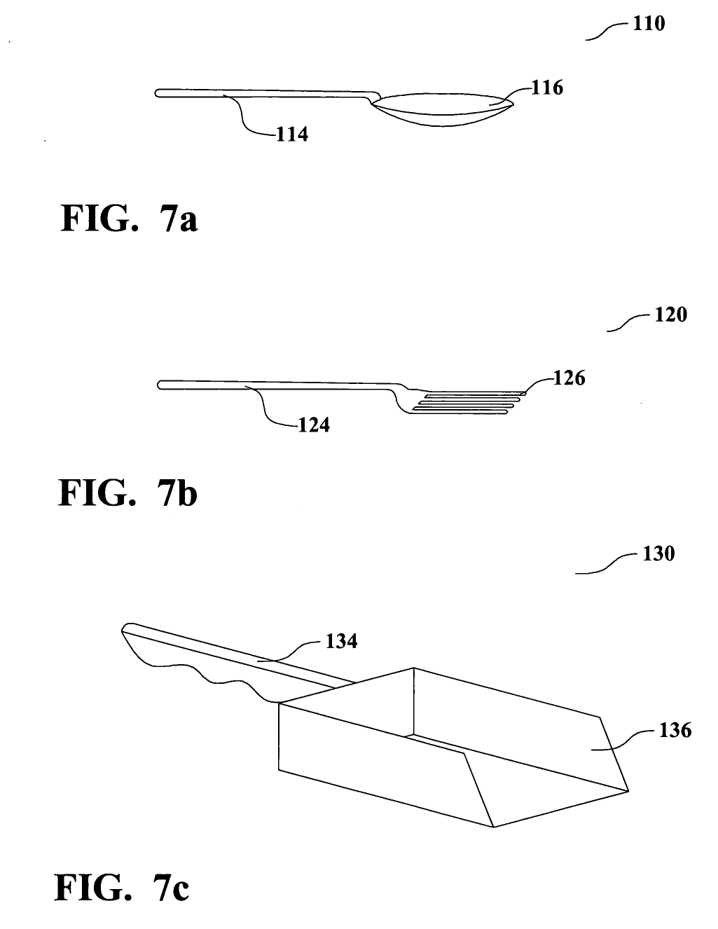

Referring now to FIGS. 7a, 7b, and 7c, sixth, seventh, and eighth preferred embodiments of the present invention are illustrated. Additional food handling devices of a spoon 110, a fork 120, and a scoop 130, or shovel, are formed of the conductive loaded resin-based material. In each case, the device comprises a food contacting surface 116, 126, and 136 and a handle 114, 124, and 134. In one embodiment, each device 110, 120, and 130 is molded of the conductive loaded resin-based material using an injection molding process.

Referring now to FIG. 1b, a second preferred embodiment of present invention is illustrated. An exemplary food container or food transporting device 16 comprising conductive loaded resin-based material is shown. The inner surface 18 is that which comes in contact with the food. The entire food container or food transporting device 16 comprises conductive loaded resin-based material thus providing a light weight, non-corrosive, thermally conductive, device which is easily fabricated in any shape and size that are desirable for the application. Specific examples of this food container or food transporting device include, but are not limited to, a tray, a pot, or a pan. The light weight characteristic of the conductive loaded resin-based food container or food transporting device of the present invention is advantageous to the ergonomic conditions of the workplace. The corrosion resistant properties of the subject device are beneficial to its durability and cleanliness in food-related applications. The corrosion resistant quality is achieved by doping a corrosion resistant base resin with corrosion resistant fibers and/or powders to create a homogeneous, corrosion resistant conductive loaded resin-based material. This corrosion resistant conductive loaded resin-based material is then molded and/or otherwise formed into any shape or size that is advantageous for the particular application.

As mentioned previously, the molded conductive loaded resin-based material exhibits excellent thermal dissipation characteristics. This is an important feature in the food industry. The food container or food transporting device 16 of the present invention provides rapid cooling of hot liquids which is essential in restaurant applications as well as food processing applications. For example, it is accepted practice in the restaurant industry to pour large batches of hot liquids, such as sauces or soups, into relatively large, shallow metal trays and place these trays in racks in the refrigerator in order to promote rapid cooling. After cooling, the same liquid is then poured into a plastic container for continued storage. In contrast, a single conductive loaded resin-based material tray, such as the food container or food transporting device 16 of the present invention, provides excellent cooling characteristics as well as excellent storage characteristics. In addition, a lid, not shown, comprising conductive loaded resin-based material is easily and economically formed to fit the tray or pan described herein. Thus, the conductive loaded resin-based material provides a food container or food transporting device 16 which is suitable for both rapidly cooling hot liquids and storing the cooled liquid. Cooling and storage are one example of the many uses of the conductive loaded resin-based material food container or food transporting device 16. Other examples include, but are not limited to, containing food as it is transported manually from one location to another, containing food as it is transported automatically via conveyor belt or other automated means, serving food, and heating food at any stage during food processing and/or food preparation. In addition, the conductive loaded resin-based food container or food transporting device 16, provides the benefit of metal detection. This is important in maintaining high quality and avoiding expensive food scrap and line downtime. As an additional advantage, the food transporting device formed of conductive loaded resin-based material is significantly lighter than typical prior art vessels formed of stainless steel.

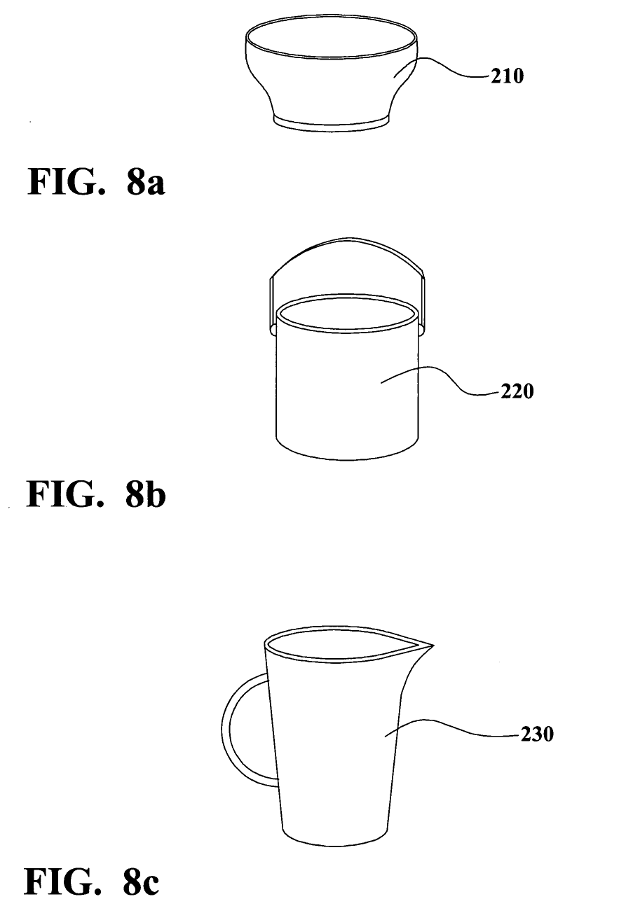

Referring now to FIGS. 8a, 8b, and 8c, ninth, tenth, and eleventh preferred embodiments of the present invention are illustrated. Additional food container devices of a bowl 210, a bucket 220, and a pitcher 230 are formed of the conductive loaded resin-based material. In one embodiment, the food container devices 210, 220, and 230 are formed by molding the conductive loaded resin-based material. In one preferred approach, a blow molding process is used. The conductive loaded resin-based material provides a thermally conductive food container wherein pieces of the material are detectable by metal detection or by magnetic detection methods. These features are combined with a significantly reduced weight when compared to typical containers formed of stainless steel.

Referring now to FIG. 1c, illustrates a third preferred embodiment of the present invention showing a glove 20 comprising conductive loaded resin-based material. The glove 20 is fabricated of flexible, cloth-like, conductive loaded resin-based material which is formed into the desired shape and size. This glove is worn on the human hand to provide cleanliness during food processing, preparation, and/or handling. The conductive loaded resin-based glove 20 provides an advantage over gloves commonly found in prior art in that the conductive loaded resin-based glove of the present invention is detectable by metal detecting equipment. This represents a very significant cost savings to the food processing facility by avoiding the opportunity for large amounts of scrapped food and line downtime associated with common plastic gloves or glove pieces being embedded in the finished food product.

Referring now to FIG. 1d, a fourth preferred embodiment of the present invention is illustrated showing a very low cost tube comprising conductive loaded resin-based material. The tube is used to transport and/or thermally condition liquids such as sauces, soups, beverages and other liquids placed inside the tube during food processing or preparation. Tube diameter 26 and wall thickness 28 are adjusted to meet the needs of each particular application. The tube offers advantages over those found in prior art. One advantage of the conductive loaded resin-based material tube 24 over common plastic tubes is that it is thermally conductive. Thus, it successfully provides rapid cooling to hot liquids when placed in a cool environment. Conversely, the conductive loaded resin-based material tube 24 provides rapid heating to cool liquids when placed in a hot environment. The conductive loaded resin-based material tube 24 of the present invention is very economical due to low fabrication costs, high durability, and ease of installation. The tube 24 is easily extruded using techniques known to the industry. The tube 24 is also economically fabricated by other means such as injection molding, over-molding or other techniques. As an option, the conductive loaded resin-based material tube 24 is threaded to provide interface with other pieces of tubing and other fittings such as elbows and connectors. As an additional option, these elbows, connectors, and other fittings, not shown, are fabricated of conductive loaded resin-based material as a part of the present invention.

This conductive loaded resin-based material tube 24 provides a corrosion resistant device suitable for transporting and/or thermal conditioning liquids. Additionally, the tube 24 is light weight and easy to install. It is formulated using food grade materials when the application so warrants. This same tube 24 is also suitable for use in other industries in addition to the food industry for transporting and/or thermally conditioning liquids.

Referring now to FIG. 1e, a fifth preferred embodiment of the present invention is illustrated. Two concentric tubes 29 of the conductive loaded resin-based material are shown. The concentric tubes 29 are used to aide in the thermal conditioning of fluids. In the case of concentric tubes, one tube carries the fluid product while the second tube carries a second fluid at a set temperature. For example, where cooling is desired, a cooling fluid such as cold water or other cold liquid is run through the center tube. Concurrently the hot liquid such as a food sauce is transported through the space between the two tubes. Thus, the hot sauce is cooled by the cold water pulling heat from the sauce through the thermally conductive wall of the conductive loaded resin-based tube of the present invention. In this example, the hot sauce is further cooled through the outer wall of the conductive loaded resin-based material tube when the concentric tubes are located in a cool environment. Alternatively, product is cooled by moving the hot product through the inner tube and moving the cooling fluid through the outer tube. In this alternate case, conductive loaded resin-based material is used for the wall of the inner tube whereas the outer tube is preferably comprised of or coated with thermally insulating material.

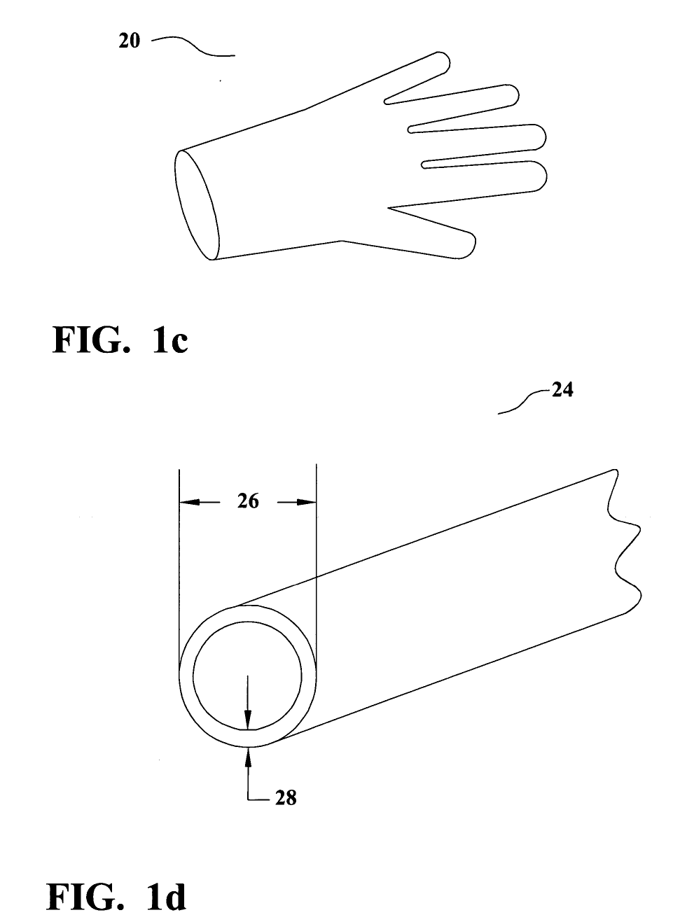

The conductive loaded resin-based material of the present invention typically comprises a micron powder(s) of conductor particles and/or in combination of micron fiber(s) substantially homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

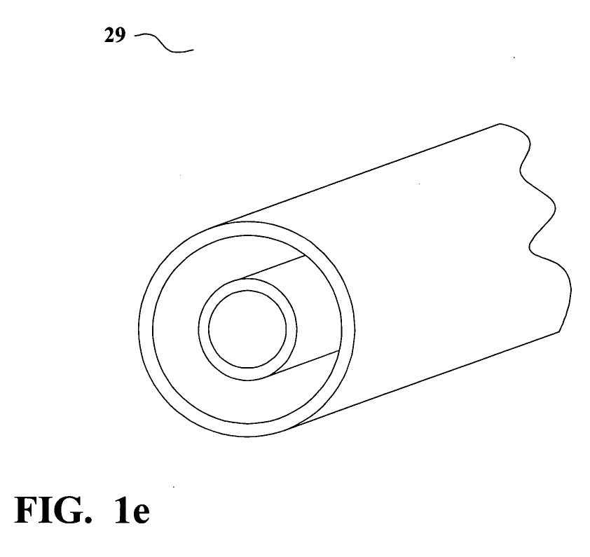

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The micron conductive fibers 38 may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, or the like, or combinations thereof. Exemplary metal plating materials include, but are not limited to, copper, nickel, cobalt, silver, gold, palladium, platinum, ruthenium, and rhodium, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

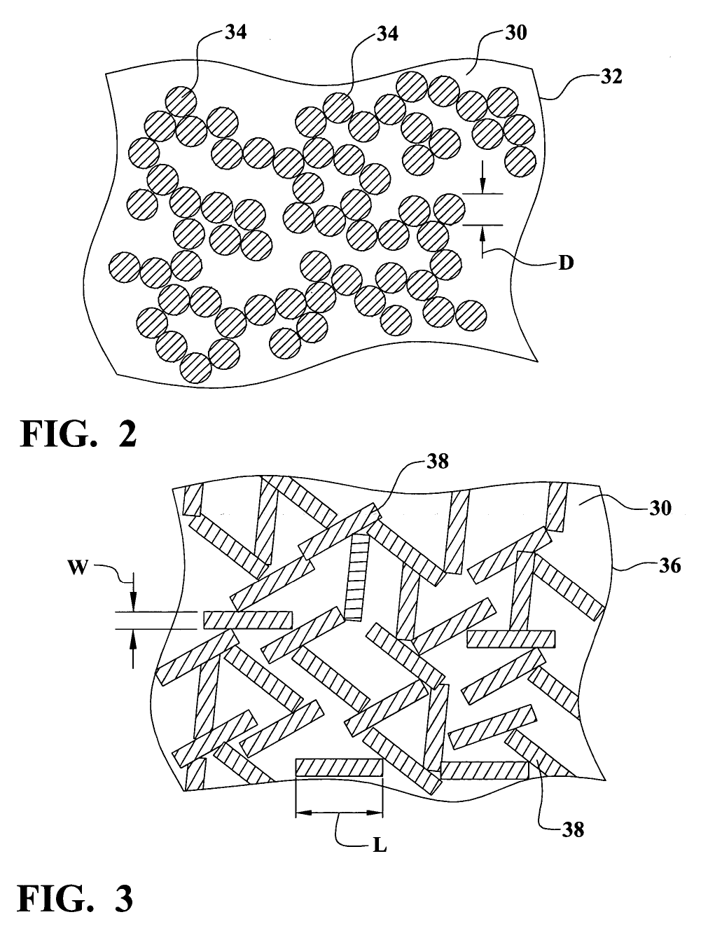

These conductor particles and/or fibers are substantially homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 6-12 micron in diameter and lengths of 4-6 mm and comprising, by weight, about 30% of the total weight of the conductive loaded resin-based material will produce a very highly conductive parameter, efficient within any EMF spectrum. Referring now to FIG. 4, another preferred embodiment of the present invention is illustrated where the conductive materials comprise a combination of both conductive powders 34 and micron conductive fibers 38 substantially homogenized together within the resin base 30 during a molding process.

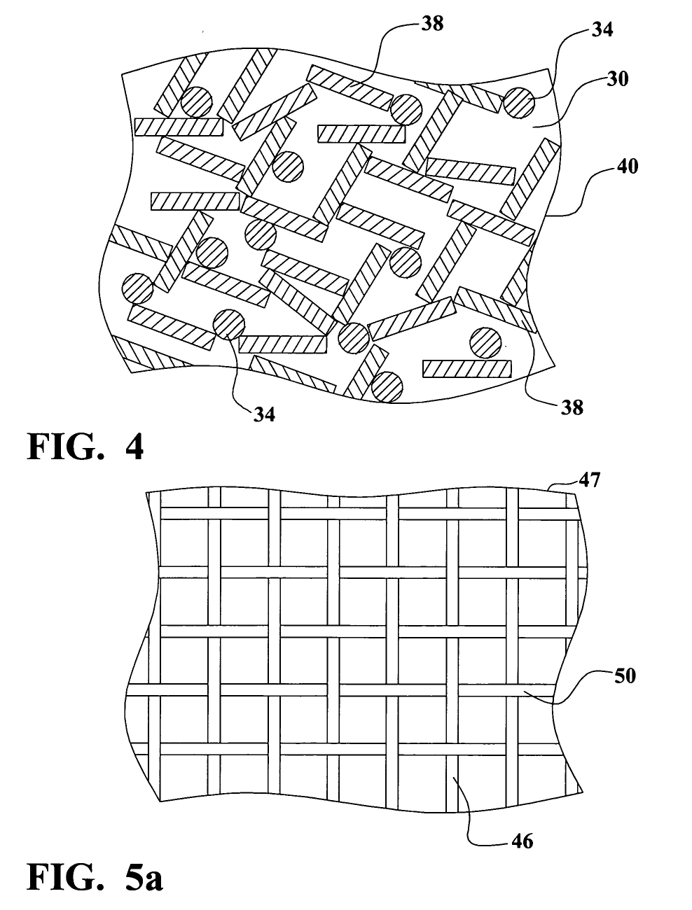

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

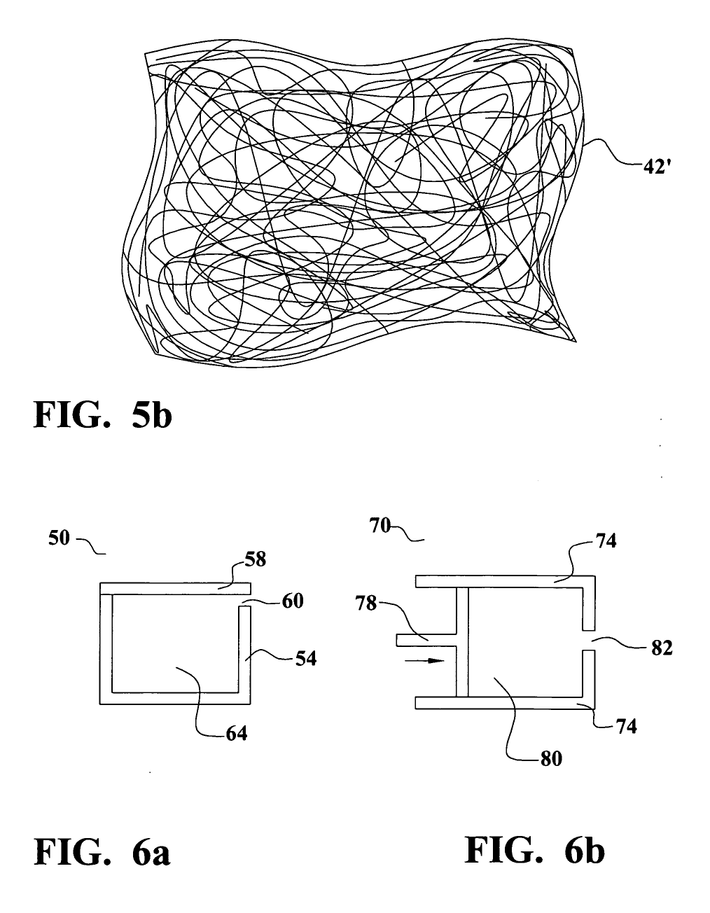

Food processing, preparation, and handling devices formed from conductive loaded resin-based materials can be formed or molded in a number of different ways including injection molding, extrusion, calendaring, or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the substantially homogenized conductive material cures by thermal reaction. The upper portion 58 and lower portion 54 of the mold are then separated or parted and the devices are removed.

FIG. 6b shows a simplified schematic diagram of an extruder 70 for forming food processing, preparation, and handling devices using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. Effective food processing, preparation, and handling devices are achieved. Methods to form food processing, preparation, and handling devices is achieved. Food handling utensil devices, such as a spoons, forks, or scoops, are formed of conductive loaded resin-based material. Food handling containers, such as mixing bowls, buckets or pitchers, are formed of conductive loaded resin-based material. Food handling tray devices are formed of conductive loaded resin-based material. Food handling glove devices are formed of conductive loaded resin-based material. Food handling piping devices are formed of conductive loaded resin-based material. The electrical or thermal characteristics can be altered or the visual characteristics can be altered by forming a metal layer over the conductive loaded resin-based material.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

1. A food handling device comprising a conductive loaded, resin-based material comprising conductive materials in a base resin host wherein the percent by weight of said conductive materials is between 20% and 50% of the total weight of said conductive loaded resin-based material.

2. The device according to claim 1 wherein said conductive materials comprise micron conductive fiber.

3. The device according to claim 2 wherein said conductive materials further comprise conductive powder.

4. The device according to claim 1 wherein said conductive materials are metal.

5. The device according to claim 1 wherein said conductive materials are non-conductive materials with metal plating.

6. The device according to claim 1 wherein said food handling device comprises:
a food contact portion; and
a handle.

7. The device according to claim 6 wherein said device is a spatula, paddle, scraper, fork, spoon, or scoop.

8. The device according to claim 1 wherein said device is a food container.

9. The device according to claim 8 wherein said food container is a tray, a bowl, a bucket, or a pitcher.

10. The device according to claim 1 wherein said device comprises a glove.

11. A food handling device comprising a hollow tube comprising a conductive loaded, resin-based material comprising conductive materials in a base resin host wherein the percent by weight of said conductive materials is between 20% and 50% of the total weight of said conductive loaded resin-based material.

12. The device according to claim 11 wherein said conductive materials are nickel plated carbon micron fiber, stainless steel micron fiber, copper micron fiber, silver micron fiber or combinations thereof.

13. The device according to claim 11 wherein said conductive materials comprise micron conductive fiber and conductive powder.

14. The device according to claim 13 wherein said conductive powder is nickel, copper, or silver.

15. The device according to claim 13 wherein said conductive powder is a non-metallic material with a metal plating.

16. The device according to claim 11 wherein said conductive loaded resin-based material further comprises a ferromagnetic material.

17. The device according to claim 11 further comprising a metal layer overlying said conductive loaded resin-based material.

18. The device according to claim 11 further comprising a second hollow tube surrounding said hollow tube with a space therebetween.

19. A food handling device comprising:
a food contact portion comprising a conductive loaded, resin-based material comprising micron conductive fiber in a base resin host wherein the percent by weight of said conductive fiber is between 20% and 50% of the total weight of said conductive loaded resin-based material; and
a handle.

20. The device according to claim 19 wherein said micron conductive fiber is stainless steel.

21. The device according to claim 19 further comprising conductive powder.

22. The device according to claim 19 wherein said micron conductive fiber has a diameter of between about 3 μm and about 12 μm and a length of between about 2 mm and about 14 mm.

23. The device according to claim 19 wherein said handle comprises said conductive loaded resin-based material.

24. The device according to claim 23 wherein said handle further comprises an outer layer of resin-based material.

25. The device according to claim 19 wherein said conductive loaded resin-based material further comprises a ferromagnetic material.
